(19) United States
(12) Patent Application Publication
(10) Pub. No.: US 2026/0255184 A1
(43) Pub. Date: Aug. 27, 2026

(54) DIGITAL TWIN ASSISTED CONFIGURATION OPTIMIZATION SYSTEMS AND METHODS IN OPEN RADIO ACCESS NETWORK

(71) Applicant: AT&T Intellectual Property I, L.P., Atlanta, GA (US)

(72) Inventors: Yuxuan Jiang, Piscataway, NJ (US); Caglar Tunc, Rutherford, NJ (US); Xuan Tuyen Tran, Bridgewater, NJ (US); Yu Zhou, Somerset, NJ (US)

(73) Assignee: AT&T Intellectual Property I, L.P., Atlanta, GA (US)

(21) Appl. No.: 19/065,257

(22) Filed: Feb. 27, 2025

(51) Int. Cl. H04W 24/02; H04B 17/318; H04L 41/5009; H04W 24/06

(52) U.S. Cl. CPC H04W 24/02; H04B 17/328; H04L 41/5009; H04W 24/06

(57) ABSTRACT

Aspects of the subject disclosure may include, for example, optimizing Radio Access Network (RAN) configurations using a digital twin engine and optimization algorithms. To simulate network scenarios with network data from the RAN, configuration value changes are applied and resulting impact on performance metrics are evaluated. The optimization algorithms determine optimal configuration values, which are then applied to the RAN. Other embodiments are disclosed.

### FIELD OF THE DISCLOSURE

The subject disclosure relates to digital twin assisted configuration optimization systems and methods in open radio access network.

### BACKGROUND

The challenges of current radio access network (RAN) planning and optimization approaches, relying on trial-and-error and human experience, struggle to cope with the growing complexity and size of modern networks. Scaling, managing complexity, meeting network demands, and limited insights hinder efficient optimization. Embracing innovative approaches leveraging data-driven analytics and intelligent algorithms is crucial to overcome these challenges, enabling operators to navigate complex interdependencies, scale seamlessly, and meet evolving network demands while ensuring optimal performance and user satisfaction.

The challenges posed by the current RAN planning and optimization demand a departure from traditional methods. By embracing data-driven analytics, intelligent algorithms, and innovative techniques like digital twins, complexities may be addressed and new possibilities can be unlocked. This evolutionary shift empowers communication network operators to optimize RAN configurations effectively, resulting in improved network performance, reduced costs, and enhanced user satisfaction.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system including a digital twin engine and functioning within the communication network of FIG. 1 in accordance with various aspects described herein.

FIG. 2B is a block diagram illustrating an example, non-limiting embodiment of another system including a digital twin engine and optimizers in accordance with various aspects described herein.

FIG. 2C is a block diagram illustrating an example, non-limiting embodiment of a RAN application implementing a digital twin engine in accordance with various aspects described herein.

FIG. 2D depicts an illustrative embodiment of a method in accordance with various aspects described herein.

FIG. 2E depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for digital twin assisted configuration optimization systems and methods in open radio access network (RAN). The systems and methods include optimizing RAN configurations using a digital twin engine and advanced optimization algorithms. To simulate network scenarios with input data from the RAN, configuration value changes are applied and impact on performance metrics are evaluated. The optimization algorithms determine optimal settings, which are then applied to the RAN. Other embodiments are described in the subject disclosure.

One or more aspects of the subject disclosure are directed to a system comprising a processing system including a processor, and a memory that stores executable instructions that, when executed by the processing system, facilitate performance of operations. The operations include loading, with a digital twin engine, network data in open RAN and a simulation setting corresponding to a target radio access network (RAN) in the open RAN; applying one or more configuration value changes to the loaded simulation setting to assess impact on a predefined performance metric; generating, with the digital twin engine, performance projection responsive to the one or more configuration value changes and indicative of a change to the predefined performance metric; transmitting the performance projection to an optimization RAN Application (rApp) for decision-making; determining, with the optimization rApp, a best set of configuration values to optimize the predefined performance metric; and outputting the best set of configuration values to one or more base stations in the target RAN.

One or more aspects of the subject disclosure are directed to a non-transitory machine-readable medium, comprising executable instructions that, when executed by a processing system including a processor, facilitate performance of operations. The operations include deploying one or more optimization radio access network Applications (rApps) in an open radio access network (RAN), where the one or more optimization rApps comprise a first rApp configured to optimize a first set of configuration value and a second rApp is configured to optimize a second set of configuration value; deploying a digital twin engine in communication with the one or more optimization rApps, wherein the digital twin engine receives a simulating setting and network data filtered for a target radio access network (RAN) and a simulator trained to output performance projection regarding a predefined performance metric; receiving a configuration value change from the first rApp; generating, with the digital twin engine, the performance projection responsive to the received configuration value change and indicating a change to the predefined performance metric; transmitting the performance projection to the first rApp for decision-making; determining, with the first rApp, a best first set of configuration value to optimize the predefined performance metric; and outputting the best first set of configuration value to one or more base stations in the target RAN.

One or more aspects of the subject disclosure are directed to a method including executing, by a processing system including a processor, a digital twin engine to receive a simulation setting selected for a given radio access network (RAN) based on network data in open RAN, where the input data includes network configuration, user traffic demand, user spatial distribution, radio frequency propagation patterns or a combination thereof; applying, by the processing system, one or more configuration value changes to the simulation setting to assess impact on predefined network performance metrics; generating, by the processing system, performance projection scores indicating the impact on the predefined network performance metrics; transmitting, by the processing system, the performance projection scores to an optimization RAN application (rApp) for decision-making, wherein the optimization rApp is deployed on a service management and orchestration (SMO) platform in the open RAN; determining, by the processing system, by the optimization rApp, a best set of configuration values to optimize the predefined network performance metrics using an optimization algorithm; and outputting, by the processing system, the best set of configuration values to one or more base stations in the given RAN via an O1 interface.

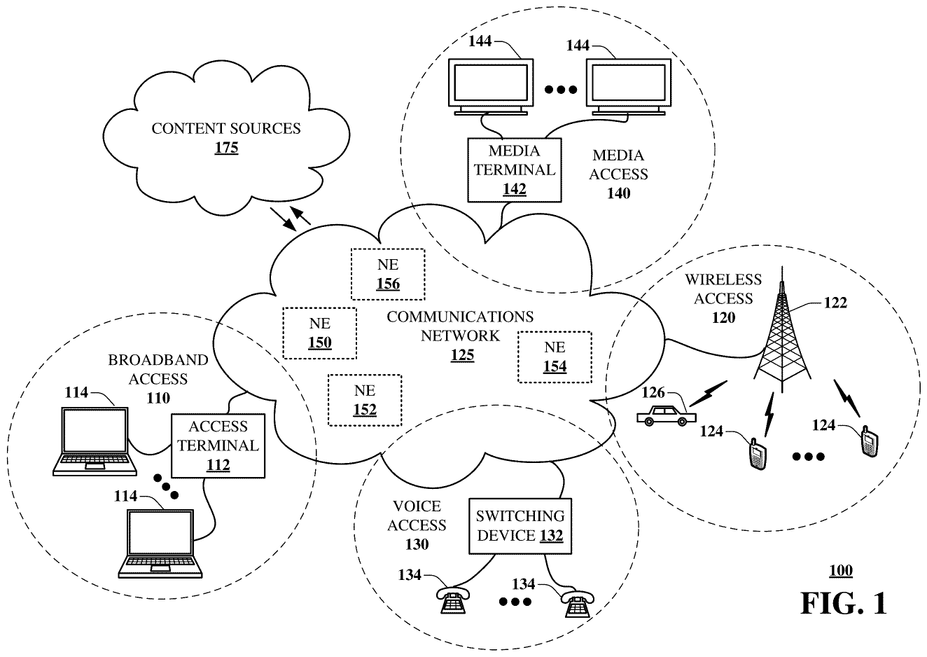

Referring now to FIG. 1, a block diagram is shown illustrating an example, non-limiting embodiment of a system 100 in accordance with various aspects described herein. For example, system 100 can facilitate in whole or in part digital twin assisted configuration optimization systems and methods in open radio access network. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

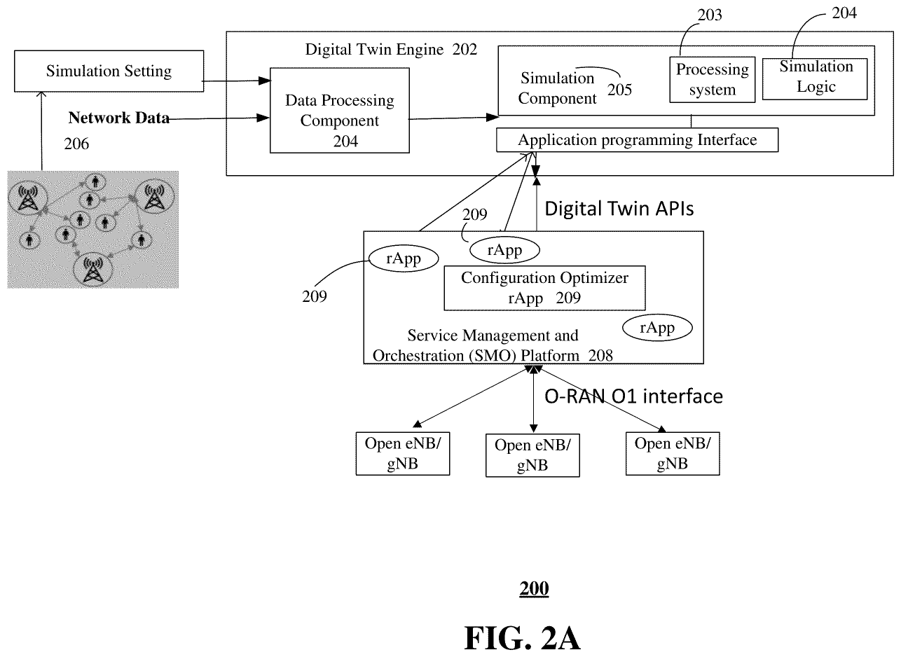

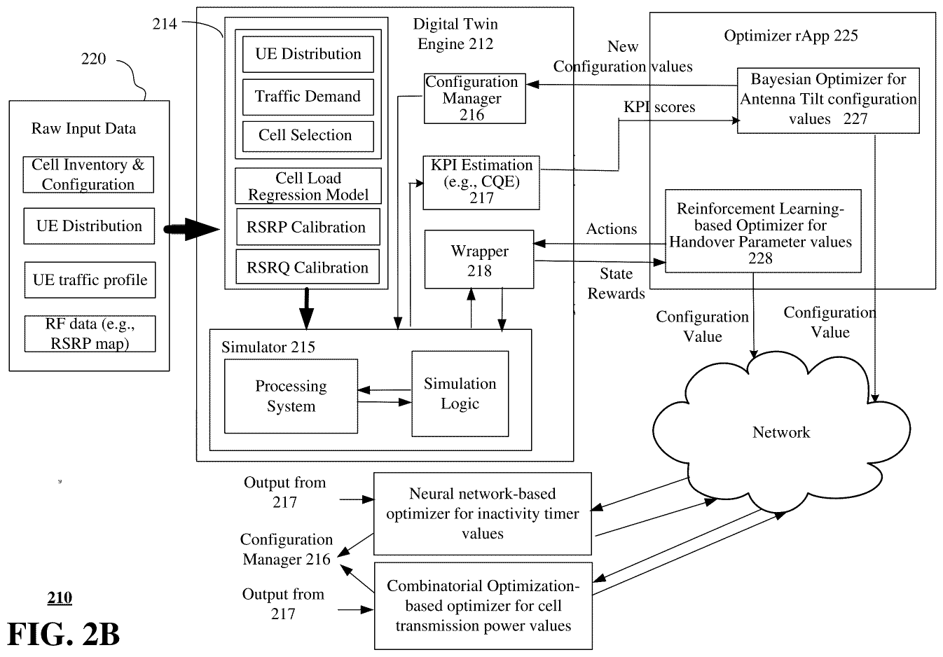

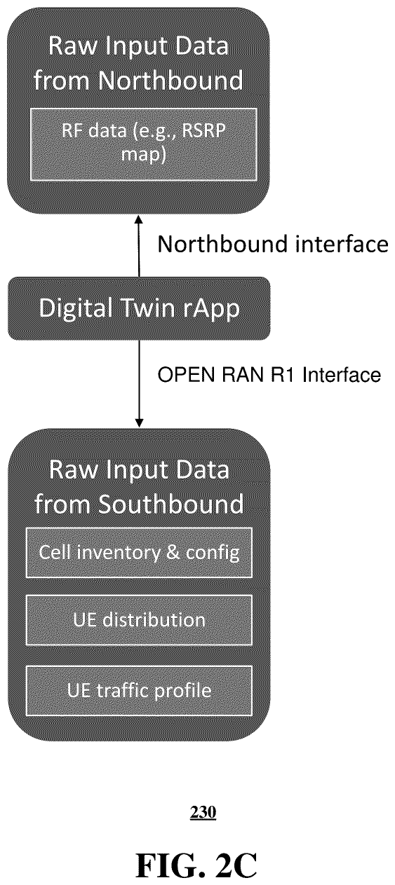

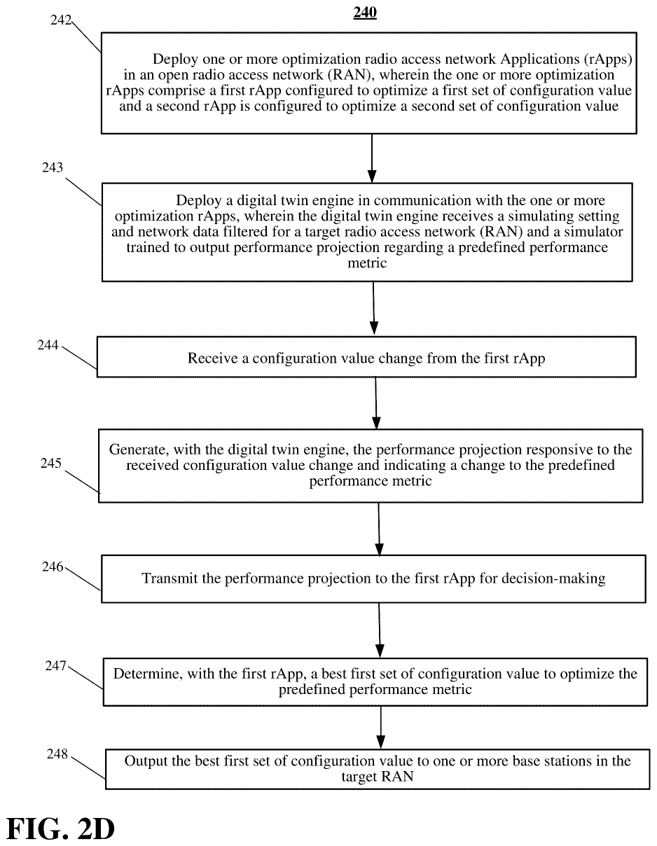

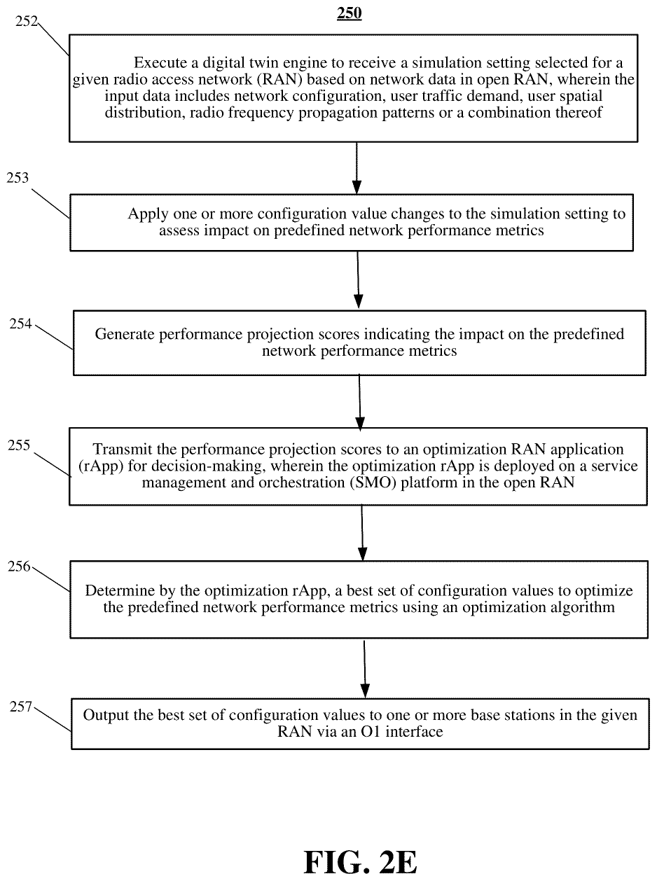

FIG. 2A is a block diagram illustrating an example, non-limiting embodiment of a system 200 functioning within the communication network of FIG. 1 in accordance with various aspects described herein.

The realm of RAN planning and optimization practices brings forth a multitude of challenges. One significant challenge lies in the large and interdependent set of parameters, encompassing site location, antenna configurations, layer management policies, and more. The metrics for evaluation are equally intricate, involving a multi-faceted measurement such as Coverage, Quality, Efficiency (CQE). Complicating matters, decision-making is often based on disjoint sets of parameters, providing only a partial view of potential impacts. For instance, expanding coverage through increased transmission power may inadvertently intensify inter-cell interference, resulting in degraded quality. Traditional trial-and-error methods, which are both costly and time-consuming, may fail to offer scalability.

There are several approaches for optimizing RAN configuration that face their own challenges in scalability and the lack of feature data. Two notable approaches are heuristic methods and pure machine learning approaches. Heuristic approaches leverage domain knowledge and expert insights to devise optimization strategies. These methods involve defining rules and guidelines based on prior experience and industry best practices. Heuristics can be effective in addressing specific optimization goals, such as coverage or interference reduction. However, heuristics often lack the ability to handle complex interactions and may not provide optimal solutions in dynamic and evolving network scenarios. Pure machine learning approaches employ algorithms to learn patterns and optimize RAN configurations based on available data. These methods typically utilize historical data, network performance metrics, and user feedback to train models that can predict optimal settings for various parameters. However, scalability can be a challenge, as large-scale deployments require extensive training data. Additionally, the lack of feature data or limitations in data availability may hinder accuracy and generalization capabilities of pure machine learning approaches.

Both heuristic and pure machine learning approaches can contribute to RAN optimization efforts. However, challenges arise in scalability, adaptability to dynamic network conditions, and the need for comprehensive feature data. To overcome these hurdles, the present disclosure utilizes innovation, leveraging data-driven analytics and intelligent algorithms to transcend the limitations of manual approaches. The present disclosure provides new and improved RAN planning and optimization using a digital twin, enhancing network performance, efficiency, and user experiences on an unprecedented scale.

Digital twins are a virtual model of a physical object, system, or process that uses real-time data to simulate its behavior. Digital twins are used to monitor operations, optimize performance, and make better decisions. The advent of performing what-if analysis and optimization using digital twins introduces a paradigm shift in various industries. By leveraging digital replicas of physical systems or processes, organizations can explore hypothetical scenarios and assess potential outcomes before implementing changes in the real world. This innovative approach allows for rigorous experimentation, risk mitigation, and cost reduction. Digital twins facilitate and enable simulating and analyzing complex systems, uncovering insights that were previously unattainable. The ability to optimize performance, identify bottlenecks, and fine-tune processes based on virtual experimentation brings unprecedented efficiency and agility.

With digital twins, mobile service providers can make informed decisions, refine strategies, and drive innovation, empowering businesses to stay ahead in a rapidly evolving landscape. Mobile service providers can harness the power of digital twins to unlock untapped potential, elevate decision-making, and pave the way for transformative advancements across industries.

As depicted in FIG. 2A, the system 200 is configured to operate in an Open Radio Access Network (RAN) environment. Open RAN's flexible architecture enables deployment of dynamic optimization strategies based on digital twin simulations. The system 200 includes a digital twin engine 202, a Service Management and Optimization (SMO) platform 208 hosting multiple RAN applications (rApps) in the open RAN environment. One type of rApps include one or more configuration optimizer rApp 209 in communication with the digital twin engine 202. The SMO platform 208 is in communication with multiple base stations such as O-eNodeB (O-eNB) and O-gNodeB (O-gNB) via O1 interface.

In various embodiments, the system 200 is configured to utilize the digital twin engine 202 in response to one or more simulating settings. The one or more simulation settings can be prepared and selected to emulate or reflect various network scenarios. The simulation settings, along with network data, are provided to the digital twin engine 202 which is configured to perform simulation based on the simulation settings and the network data, allowing RAN operators to evaluate different configurations, parameters, and policies before implementing changes in the live network. Referring back to FIG. 2A, the digital twin engine 202 includes a data processing component 204 and a simulation component 205, as depicted in FIG. 2A. The data component 204 receives the network data and the one or more simulation settings, as an input, and is configured to preprocess or prepare the input for the simulation component 205. In some embodiments, the data processing component 204 may include a filtering module which is configured to filter the network data based on the one or more simulation settings. Filtering of the network data based on the one or more simulation settings may reduce and customize a vast amount of the network data to be relevant to a target RAN environment where network operators intend to assess impact of particular or specific configuration value changes on network performance metrics.

In various embodiments, the one or more simulation settings address a plurality of simulation scenarios relevant to a target RAN. The target RAN has network topology such as placement of base stations, particular cell sites, user equipment distribution, etc. The plurality of simulation scenarios define and determine various simulation settings to reflect and/or represent topology, environments, structures, arrangements, components/entities, etc. in the target RAN. The network data include, for instance, network configuration, user traffic demand, user spatial distribution, RF propagation pattern, etc. By way of example, the one or more simulation settings focus on or target, time and duration of interest, cells of interest, configuration parameters of interest, such as configuration parameter values such as antenna tilt values, handover parameter values, inactivity timer values, cell transmission power values, etc., and output key performance indicators (KPIs) of interest. For instance, time and duration of interest can be busy hour, off-peak hour, cells of interest may include cells that cover a large event, etc. Configuration parameters of interest are directed to particular parameter values. The simulation settings further target user distribution and mobility pattern, traffic volume, and user capability reflecting different types of user equipment (UEs) such as IoT devices, smartphones, etc. In some embodiments, the simulation settings can be pre-generated (for static configuration optimization), generated on-the-fly during network operation (such as hourly by way of example) to capture dynamics in the network, user mobility and traffic pattern, or a prediction of user mobility and traffic pattern in the next optimization time window (for example, next hour).

As depicted in FIG. 2A, the simulation component 205 includes a processing system 203 and a simulation logic 204. In some embodiments, the processing system 203 is implemented with artificial intelligence/machine learning (AI/ML) models including neural networks. The simulation logic 204 is configured to perform simulation with respect to different simulation settings involving, for example, different configuration parameters. For instance, the simulation logic 204 is programmed to output a Key Performance Indicator (KPI) in response to different configuration parameters.

In one or more embodiments, the simulation logic 204 is configured to utilize artificial intelligence/machine learning (AI/ML) technologies. AI/ML models are trained based on the simulation scenarios to output performance projection regarding predefined performance metrics. For instance, the predefined performance metrics include coverage, capacity, or a combination of multiple different metrics. In order to train AI/ML models, network states can be simulated for small settings for which no training data is available and the simulation results are then used for training AI/ML models. The trained AI/ML models are provided with real world data and can be used to predict performance such as predicting estimated KPIs. By using the trained AI/ML models, the simulation logic 204 generate predicted KPIs for a given set of the network data and configuration parameters.

In one or more embodiments, trained AI/ML models can generate performance projection in response to configuration value change(s) and the performance projection indicates impact of the configuration value changes to the predefined performance metrics such as certain changes to the predefined performance metrics. By way of example, the performance projection includes output KPIs of interest, for instance, average throughput, average Physical Resource Block (PRB) utilization, average Reference Signal Received Quality (RSRQ), etc. In a 5G network, a Physical Resource Block (PRB) is the smallest unit of resources that can be allocated to a user, having a specific number of subcarriers over a given time slot. PRBs are used to manage and optimize the allocation of radio resources, enabling efficient use of the available spectrum to support high data rates and low latency communication. Reference Signal Received Quality (RSRQ) in 5G networks is a key performance indicator that measures the quality of the received signal by considering both the signal strength and the level of interference. It is calculated as the ratio of Reference Signal Received Power (RSRP) to the total received power, including interference and noise, providing insights into the network's ability to maintain reliable and efficient communication. In one embodiment, the output KPIs can be used as training data. With the training, the simulation component 205 may predict KPIs over real world data in real time.

In one or more embodiments, the digital twin engine 202 can be used to perform simulation with respect to the one or more simulation settings and provide simulation results to be used to optimize a given RAN. Determining and applying the best values for configuration parameters to the given RAN may lead to optimization of predefined performance metrics in the given RAN. To optimize the given RAN network, selecting parameters for the one or more simulation settings is a complex and important process. In various embodiments, parameters selected in the system 200 include temporal evolution of network scenarios such as peak hours vs. off-peak hours. In some embodiments, simulation settings may be generated based on a set of snapshots to represent several scenarios including busy-hour (BH), off-peak hour (OH), etc. For example, BH snapshot can be created by averaging the traffic demand within the same time window from 10 AM-2 PM over multiple days. Simulation snapshots are created periodically (e.g., every hour), based on prediction of network states (traffic volume, a number of UEs, etc.) in the next time window. As another example, simulation and optimization are done in advance during 10:50-11:00 and apply for future period 11:00-12:00. This way very fresh data are used and can reflect upcoming network situations accurately.

The temporal evolution of network scenarios varies with user distribution, user traffic demands, major events, network failures/drop issues. Another parameter includes network configuration parameters such as antenna tilt value, cell transmission power values, handover standard parameters, etc. Additionally or alternatively, parameters may be selected based on factors such as computing power, actual network settings (static or sparse user distribution vs. busy and dynamic user distribution), etc. With respect to the simulation settings, the digital twin engine 202 performs simulations and provide performance projections for optimization. Optimization may find best configuration values for each BH snapshot and the same optimal configuration for this BH snapshot is applied every day. As another example, optimization is triggered for every hour future snapshot to generate new configurations. As further another example, data are gathered and used to create a dataset of mapping from network state to configuration actions and rewards. A Reinforcement Learning agent is trained using collected dataset to improve decision-making policy. The Reinforcement Learning enables continuous monitoring and continuous adjustment of the network and brings more flexibility. Applying the Reinforcement Learning can accommodate network parameter changes at every second and take into account the real time network. The Reinforcement Learning agent is trained such that it can find the network running into the situation where it needs a parameter adjustment at any time when the Reinforcement Learning agent determines that it is a proper time to do so.

As depicted in FIG. 2A, the digital twin engine 202 is in communication with the SMO 208 where various rApps are hosted. FIG. 2A illustrates multiple rApps 209 configured to perform configuration optimization. In various embodiments, the multiple rApps 209 are configured to determine best values for configuration parameters and provide the best values to the given RAN for optimization.

In various embodiments, the rApps 209 interact with the digital twin engine 202 to perform analysis of rApps and obtain projection of performance in various scenarios. More specifically, the digital twin engine 202 receives command from the rApps 209 to (i) load existing scenario or create new scenario (e.g., different or new parameters or parameter values), (ii) apply a new configuration value change or multiple configuration value changes, and (iii) send back estimated performance scores to the rApps 209 for decision-making. The digital twin engine 202 is configured to perform simulation using the digital twins with respect to existing scenarios or new scenarios before applying to the actual RAN network. The projection from the digital twin engine 202 can be used to improve network performance.

FIG. 2A depicts the configuration optimizer rApp 209 deployed on the open RAN SMO platform 204. The rApp 209 interacts with open eNodeBs (O-eNBs)/open gNodeBs (O-gNBs) through O1 interface. The rApp 209 interacts with the digital twin engine 202 through digital twin Application Programming Interfaces (APIs) which can be realized using appropriate protocol of choice such as REST or open-source APIs that support multiple programming languages and suitable for microservice architectures available in the relevant technical field. REST API, or Representational State Transfer Application Programming Interface, is a set of rules and conventions for building and interacting with web services. REST API is based on the principles of REST architecture, which uses stateless communication and standard HTTP methods such as GET, POST, PUT, DELETE, and PATCH to perform operations on resources identified by URLs. REST APIs are designed to be simple, scalable, and flexible, allowing different systems to communicate over the web using a uniform interface. Rest API is widely used in web development due to their ability to handle a wide range of data formats, including JSON and XML, making them suitable for various applications and services.

The system 200 takes an iterative approach to optimization, enabled by the digital twin engine 202 within the Open RAN framework, as depicted in FIG. 2A, which may ensure continuous refinement and improvement of network performance. Optimizing the RAN configuration through the utilization of digital twins extends beyond traditional optimization methods and encompasses static optimization, dynamic online optimization, and machine-learning-based optimization techniques, as will be described in detail later. To implement the RAN configuration optimization through the digital twins, the digital twin engine 202 operates with the rApps 209 within an Open RAN SMO platform 208. This integration allows for seamless deployment and integration into existing RAN infrastructure, providing a scalable and adaptable solution for optimizing RAN configuration using digital twins. The utilization of digital twins and hybrid approaches that combine domain expertise, machine learning techniques, and data-driven insights can help address these challenges and further enhance RAN configuration optimization.

FIG. 2B is a block diagram illustrating an example, non-limiting embodiment of a system 210 in accordance with various aspects described herein. The system 210 includes a digital twin engine 212 configured to receive raw input data 220. By way of example, the raw input data 220 include cell inventory and configuration, user equipment (UE) distribution, UE traffic profile, radio frequency (RF) data (e.g., Received Signal Received Power (RSRP) map). The digital twin engine 212 is in communication with optimizers 225 which in turn communicate with the network.

In one or more embodiments, the raw input data 220 is used to construct a simulation scenario. The simulation scenario describes specific network settings on which simulation is going to run. For instance, a network operator may run simulation on Tuesday morning between 10 am and 1 pm (i.e., a time and duration of interest) to understand an average throughput and an average PRB utilization for the cells of interest (e.g., a few cells on a busy street, such as Wall Street). In order to run the simulation, it may be necessary to specify a corresponding value of a particular parameter such that a digital twin is used to project performance and output KPIs. The digital twin engine 212 takes in the raw input data 220 such as cell inventory, cell configuration data, UE graphical distribution, UE traffic profile such as UE temporal demands, RF data (e.g., RF prediction, a RSRP map) etc. The RSRP map may be generated for each individual cell and provided as one of inputs to the digital twin engine 212. In some embodiments, the raw input data 220 include historical network data. In other embodiments, the raw input data 220 include immediate streaming data and/or can contain some prediction.

In one or more embodiments, the digital twin engine 212 reads the raw input data 220 by executing SQL queries of databases on demand. The databases that store the raw input data 220 are present in a network operator's systems and the digital twin engine 212 has access to such databases. The digital twin engine 212 is arranged to be in communication with the SMO (as shown in FIG. 2A) or alternatively, the digital twin engine may be implemented as an application such as a rApp hosted in the SMO platform, as will be further described in connection with FIG. 2C later. The digital twin engine 212 includes a standard interface that can communicate with the SMO platform over A1 interface and may read a large amount of data relating to cell configuration, UE distribution, etc. Additionally or alternatively, the digital twin engine 212 may be allowed to take in customized data from northbound, i.e., outside of open RAN.

The digital twin engine 212 includes a data processing component 214. As depicted in FIG. 2B, the data processing component 214 include UE distribution, traffic demand, cell selection, cell load regression model, RSRP calibration, and RSRQ calibration by way of example. The present disclosure is not limited thereto and other modules can be used. In the data processing component 214, a UE distribution module, a traffic demand module, and a cell selection module may perform preprocessing of the raw input data 220 such as preprocessing the UE distribution and traffic demand to extract key statistical characteristics. Similarly, preprocessing of the cell inventory data and configuration table is performed to extract necessary information that is needed to generate the output. The data processing component 214 may perform data processing, data filtering and/or data cleaning.

As depicted in FIG. 2B, the cell load regression model relates to output of average PRB. A simplified version of the raw input data would be a number of users which will lead to higher PRB utilization. In order to project KPIs, the regression model can be used and take in various data as an input variable and through regression, KPIs of interest can be output. The cell load regression model predicts relationship between KPIs and cell load and is generated accordingly. The cell load regression model is included in the data processing component 214 and can be functioned as an auxiliary evaluator or simulator. RSRP calibration and RSRQ calibration modules indicate that a distribution of RSRP calculated computer is calibrated with reference to real world ground truth data. The computer generated RSRP may be adjusted and fine-tuned to reflect the real-world ground truth data.

The digital twin engine 212 further includes a simulator 215 which is configured to run simulations in parallel. The simulator 215 may include different kinds of evaluators. The data processing component 214 receives the raw input data 220 and preprocess or processes the raw input data 220 to be fed to the simulator 215. As one example, the simulator 215 may be implemented as an NS-3 simulator. The NS-3 simulator is a discrete-event network simulator widely used for research and educational purposes in the field of computer networking. The NS-3 simulator provides a detailed simulation environment for modeling the behavior and performance of various network protocols and architectures, including wireless, wired, and satellite networks. NS-3 is designed to be highly modular and flexible, allowing users to customize and extend its functionality to suit specific research needs. The NS-3 simulator supports a wide range of network technologies and protocols, making it a valuable tool for simulating complex network scenarios and evaluating the performance of new networking concepts and algorithms.

In one or more embodiments, the simulator 215 may run parallelized simulations and serve as a parallelized evaluator. The simulator 215 may include various logics configured to simulate beamforming, RRC scheduling, etc. in order to generate corresponding KPI output. As depicted in FIG. 2B, the simulator 215 includes a processing system and a simulation logic as described in detail above in connection with FIG. 2A. In some embodiments, the simulation component 215 is configured to utilize artificial intelligence/machine learning (AI/ML) technologies. The simulation component 215 utilizes AI/ML models trained based on network data and simulation settings as input and KPIs as output. KPIs indicate performance projection regarding predefined performance metrics. For instance, the predefined performance metrics include coverage, capacity, or a combination of multiple different metrics. Trained AI/ML models can generate performance projection in response to configuration value change(s) and the performance projection indicates impact of the configuration value changes to the predefined performance metrics such as certain changes to the predefined performance metrics.

In one or more embodiments, the simulator 215 receives configuration parameter values 216 from the optimizers 225 (e.g., different antenna tilt values, different handover parameters, different inactivity timer values, etc.). Decision of specific parameters are made outside of the digital twin engine 212 as the digital twin engine 212 provides performance projection. The optimizers 225 provide specific parameters which vary depending on applications such as a dedicated power optimization application, etc.

As depicted in FIG. 2B, application programming interfaces (APIs) are between the simulator 215 and the optimizers 225. APIs include a configuration manager 216, a KPI estimation module 217, and a wrapper 218. The configuration manager 216 receives new configuration parameters from the optimizers 225. The KPI estimation module 217 provides performance projection such as channel quality estimate (CQE) to the optimizers 225. The wrapper 218 serves as a standard interface to applications that involve a large number of iterations, such as a Reinforcement Learning optimizer 228, as depicted in FIG. 2B. As the Reinforcement Learning optimizer 228 involves a large number of iterations to take a better action, the wrapper 218 is configured to handle the large number of iterations at a faster phase. The wrapper 218 may be a bidirectional API where client applications can do read and write in one place, whereas the configuration manager 216 is a write-only API, and the KPI estimation API 217 is a read-only API.

In one or more embodiments, the optimizers 225 are implemented as rApps deployed in the SMO as depicted in FIG. 2A. The optimizers 225 apply configuration value changes to the digital twin engine 212, collect performance feedbacks and may repeat the process multiple times or iteratively to determine a best set of configuration values to optimize a defined performance metric (such as coverage, capacity, or a combination of multiple metrics). The optimization algorithm used in the optimizers 225 can leverage different techniques such as black-box Bayesian Optimization, or Reinforcement Learning, by way of example only. Black-box Bayesian Optimization is a probabilistic model-based optimization technique used to find the minimum or maximum of an objective function that is expensive to evaluate and lacks an analytical form. It leverages a surrogate model, typically a Gaussian process, to predict the function's behavior and uses an acquisition function to balance exploration and exploitation, efficiently guiding the search for optimal solutions. Reinforcement Learning (RL) is a type of machine learning where an agent learns to make decisions by interacting with an environment to maximize cumulative rewards. The agent uses trial and error to explore different actions, receiving feedback in the form of rewards or penalties, and adjusts its strategy to improve performance over time.

In one or more embodiments, Bayesian Optimizer and Reinforcement Learning based optimizer are examples of candidate algorithms used for the optimizers 250 and the present disclosure is not limited thereto. As depicted in FIG. 2B, neural network-based optimizer algorithm and combinatorial optimization-based optimizer algorithm can be used as well. The Bayesian optimizer 227 is configured to optimize, for example, antenna tilt values. The tilt value refers to the angle at which a cell antenna is tilted. Modern antennas use “electrical tilt” which allows for dynamic adjustments to the tilt angle electronically. By adjusting the electrical tilt value using a Bayesian Optimization algorithm, the network coverage could be improved with controlled inter-cell interference. The Reinforcement Learning optimizer 228 is configured to optimize, for example, handover values. Handover parameters are settings that control how a mobile user switches between different cells. Derived by a Reinforcement Learning approach, an improved set of handover parameter values can ensure more seamless cell transition while a user is in a call or data transmission session, improving the overall network retainability and reducing call drops. These optimizers run in parallel and independent of each other, interacting with the digital twin engine 212.

As another example, the neural network-based optimizer can be used to optimize inactivity timer configuration. The inactivity timer value controls when to disconnect a user's Radio Resource Control (RRC) connection after a specified period of time with no active data transmission. An optimized inactivity timer value can timely release network resources and conserve users'battery life. The inactivity timer value can be inferred using a neural network model. The combinatorial optimization-based optimizer is configured to optimize cell transmission power values. The transmission power values of a cell can be dynamically reconfigured to optimize the cell coverage and minimize the interference with adjacent cells. However, the present disclosure is not limited thereto and other optimizers based on different applications can be included and available.

In various embodiment, the digital twin engine 212 provides the projected output like KPI estimation to the optimizers 225. The optimizers 225 determines, based on the performance projection from the digital twin engine 212, whether configurations simulated by the digital twin engine 212 correspond to a best configuration or not. The optimizers 225 try to determine a best set of configuration values based on the performance projection from the digital twin engine 212. This process may be repeated and iteratively performed to determine the best set of configuration values. Once the best configuration settings are determined by the optimizers 225 for a given scenario, the best configuration settings can be applied to the actual open eNodeB/gNodeB via O1 interface, as depicted in FIG. 2A. For instance, the best set of configuration parameter values is communicated and provided to the real network after the simulation by the digital twin engine 212 is performed.

FIG. 2C is a block diagram illustrating an example, non-limiting embodiment of a system 230 in accordance with various aspects described herein. The system 230 depicts a digital twin implemented as an rApp in open RAN environment. As depicted in FIG. 2C, the digital twin rApp receives raw input data from northbound via a northbound interface. The raw input data from northbound include RF data such as a RSRP map. The digital twin rApp also receives raw input data from southbound, such as cell inventory and configuration, UE distribution, UE traffic profile, etc. The digital twin engine rApp may read a large amount of data relating to cell configuration, UE distribution, etc. over an R1 interface. Additionally, the digital twin engine rApp may be allowed to take in customized data from northbound, i.e., outside of open RAN, as depicted in FIG. 2C.

FIG. 2D depicts an illustrative embodiment of a method in accordance with various aspects described herein. In one or more embodiments, the method 240 includes deploying one or more optimization radio access network (RAN) Applications (rApps) in an open radio access network (RAN), where the one or more optimization rApps comprise a first rApp configured to optimize a first set of configuration value and a second rApp configured to optimize a second set of configuration value (Step 242). The method 240 further includes deploying a digital twin engine in communication with the one or more optimization rApps, where the digital twin engine receives a simulating setting and network data filtered for a target radio access network (RAN) and a simulator trained to output performance projection regarding a predefined performance metric (Step 243). The method 240 also involves receiving a configuration value change from the first rApp (Step 244). Subsequently, the method 240 generates, with the digital twin engine, the performance projection responsive to the received configuration value change and indicating a change to the predefined performance metric (Step 245). The method 240 then transmits the performance projection to the first rApp for decision-making (Step 246). Following this, the method 240 determines, with the first rApp, a best first set of configuration value to optimize the predefined performance metric (Step 247). Finally, the method 240 outputs the best first set of configuration value to one or more base stations in the target RAN (Step 248).

The method 240 further includes receiving, at the digital twin engine, a plurality of simulation settings prepared based on the network data relevant to the target RAN. The network data comprises network configuration, user traffic demand, user spatial distribution, radio frequency propagation pattern or a combination thereof. The simulation settings reflect time and duration of interest, one or more cells of interest, one or more configuration parameters of interest, one or more Key Performance Indicators (KPI) or a combination thereof. The method 240 further includes generating the plurality of simulation settings, which comprises generating a static configuration simulating setting, a dynamic configuration simulating setting, or a prediction-based configuration simulating setting. The method 240 further includes, with the digital twin engine, receiving a command from the first rApp and, in response to the command, applying the configuration value change to the simulation setting to generate the performance projection in the form of Key Performance Indicator scores.

The method 240 further includes implementing the one or more optimization rApps by using one or more optimization algorithms, where the first rApp utilizes a Reinforcement Learning optimization algorithm for optimizing handover parameter values and the second rApp utilizes a Bayesian optimization algorithm for optimizing antenna tilt configuration values. Additionally or alternatively, a third rApp utilizes a combinatorial optimization-based optimization algorithm for cell transmission power values and a fourth rApp utilizes a neural network-based optimization algorithm for inactivity timer configuration values. The method 240 further includes facilitating communications between the one or more optimization rApps and the digital twin engine via a plurality of application programming interfaces (APIs), where the APIs include a wrapper API interfacing with the first rApp configured to perform Reinforcement Learning-based optimization.

FIG. 2E depicts an illustrative embodiment of another method in accordance with various aspects described herein. In various embodiments, the method 250 includes executing, by a processing system including a processor, a digital twin engine to receive a simulation setting selected for a given radio access network (RAN) based on network data in open RAN, wherein the network data includes network configuration, user traffic demand, user spatial distribution, radio frequency propagation patterns or a combination thereof (Step 252). The method 250 further includes applying one or more configuration value changes to the simulation setting to assess the impact on predefined network performance metrics (Step 253). The method 250 also involves generating performance projection scores indicating the impact on the predefined network performance metrics (Step 254). Subsequently, the method 250 transmits the performance projection scores to an optimization RAN application (rApp) for decision-making, wherein the optimization rApp is deployed on a service management and orchestration (SMO) platform in the open RAN (Step 255). Following this, the method 250 determines, by the optimization rApp, a best set of configuration values to optimize the predefined network performance metrics using an optimization algorithm (Step 256). Finally, the method 250 outputs the best set of configuration values to one or more base stations in the given RAN via an O1 interface (Step 257).

The method 250 further includes deploying the optimization rApp, which incorporates a Reinforcement Learning model as the optimization algorithm that continuously learns from the network data to improve decision-making policies for handover parameter values. Additionally or alternatively, the method 250 further includes deploying the optimization rApp, which utilizes a Bayesian optimization model as the optimization algorithm to determine the best set of configuration values for antenna tilt configuration values.

The method 250 further includes generating performance projections that include Key Performance Indicators (KPIs) such as average throughput, average Physical Resource Block (PRB) utilization, and average Reference Signal Received Quality (RSRQ). The method 250 further includes implementing a feedback loop where the performance of the best set of configuration values output to the given RAN is monitored, and the monitoring results are used to refine the simulation setting and the determination of the best set of configuration values.

While for purposes of simplicity of explanation, the respective processes are shown and described as a series of blocks in FIGS. 2D-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above described embodiments, the integration of digital twin in the loop when optimizing network configuration brings substantial improvements compared to conventional approaches. By leveraging digital twins, network configurations can be thoroughly tested, evaluated, and fine-tuned in a virtual environment before being applied to the actual network. This approach offers several key advantages. Digital twin-based optimization allows for comprehensive exploration of network configurations, enabling the identification of optimal settings with precision. Through iterative testing and fine-tuning, the digital twin environment provides a platform for maximizing performance, efficiency, and coverage, leading to superior network optimization outcomes.

By simulating proposed network configuration value changes in a digital twin, potential risks and negative impacts can be identified and mitigated before implementation. This proactive evaluation minimizes the risk of disruptive network issues, reduces downtime, and avoids costly mistakes in the live network environment. Digital twins provide a holistic view of the network and its performance, offering real-time insights and analytics. This comprehensive understanding enables informed decision-making based on data-driven evidence, leading to more effective and strategic optimization choices. Digital twins facilitate an iterative approach to network configuration optimization. Changes can be made, evaluated, and refined in the virtual environment, allowing for continuous improvement and fine-tuning. This iterative refinement process maximizes the potential of the network and optimizes its performance over time. In summary, the incorporation of digital twin in the loop for optimizing network configuration yields significant improvements over conventional approaches. It ensures improved optimality, reduced risks, enhanced decision-making, and enables iterative refinement. By leveraging the power of digital twins, network operators can achieve superior network optimization, leading to enhanced performance, efficiency, and ultimately, improved user experiences.

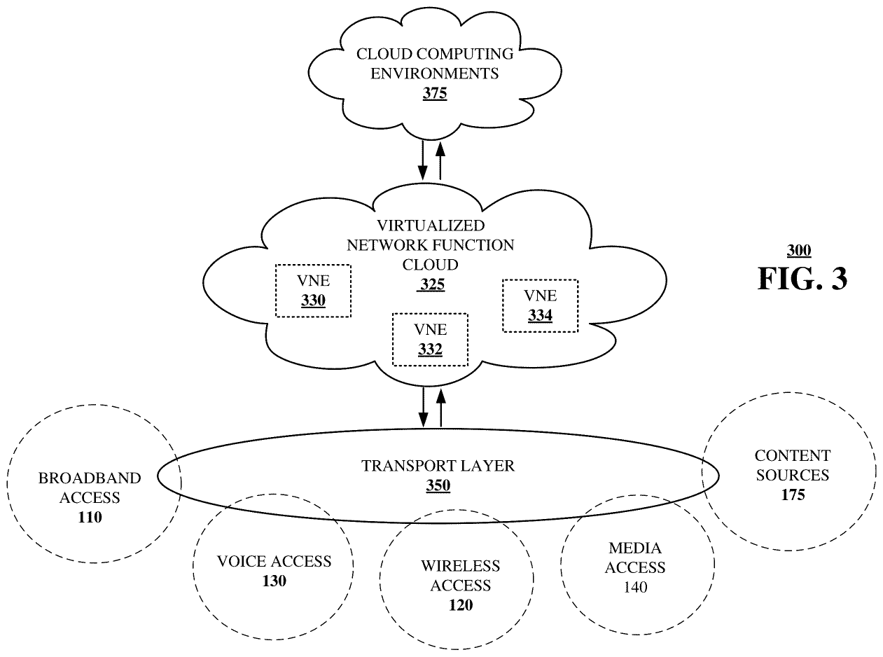

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part digital twin assisted configuration optimization systems and methods in open radio access network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

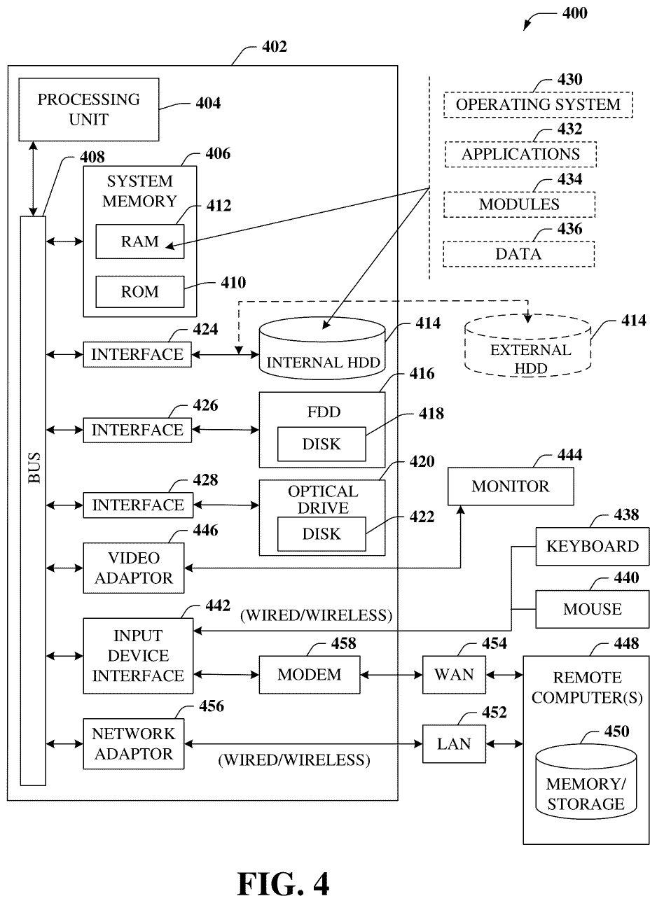

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part digital twin assisted configuration optimization systems and methods in open radio access network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

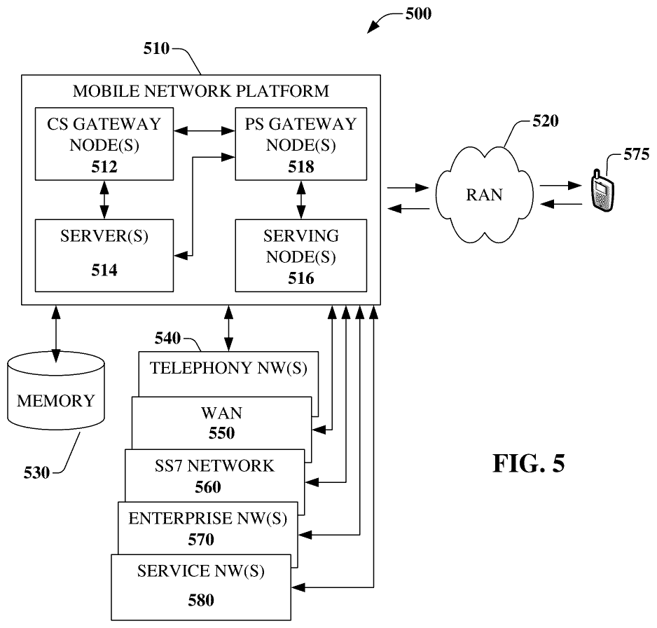

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part digital twin assisted configuration optimization systems and methods in open radio access network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

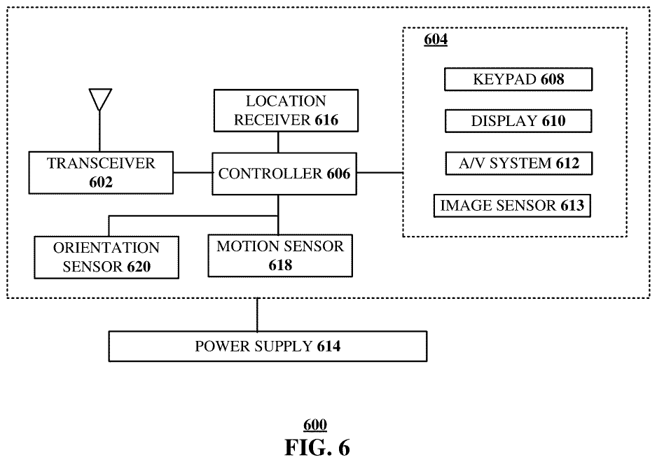

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part digital twin assisted configuration optimization systems and methods in open radio access network.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a processing system including a processor; and
a memory that stores executable instructions that, when executed by the processing system, facilitate performance of operations, the operations comprising:
loading, with a digital twin engine, network data in open radio access network (open RAN) and a simulation setting corresponding to a target radio access network (RAN) in the open RAN;
applying one or more configuration value changes to the loaded simulation setting to assess impact on a predefined performance metric;
generating, with the digital twin engine, performance projection responsive to the one or more configuration value changes and indicative of a change to the predefined performance metric;
transmitting the performance projection to an optimization RAN Application (rApp) for decision-making;
determining, with the optimization rApp, a best set of configuration values to optimize the predefined performance metric; and
outputting the best set of configuration values to one or more base stations in the target RAN.

2. The system of claim 1, wherein the operations further comprise receiving a command from the optimization rApp, and wherein the loading the simulation setting comprises loading the simulation setting in response to the received command, wherein the simulation setting include time and duration of interest, one or more cells of interest, one or more configuration parameters of interest, one or more Key Performance Indicators (KPI) or a combination thereof.

3. The system of claim 1, wherein the operations further comprise:
generating a plurality of simulation settings; and loading one or more of the plurality of simulation settings;
wherein the plurality of simulation settings comprises a pre-generated setting or an on-the-fly generated setting during network operation.

4. The system of claim 1, wherein the network data from the target RAN comprises network configuration, user traffic demand, user spatial distribution, radio frequency (RF) propagation pattern or a combination thereof.

5. The system of claim 1, wherein the transmitting the performance projection further comprise transmitting Key Performance Indicator (KPI) scores via an application programming interface (API) between the digital twin engine and the optimization rApp.

6. The system of claim 1, wherein the operations further comprise iteratively performing the application of the one or more configuration value changes and the generation of the performance projection until the best set of configuration values is determined by the optimization rApp, wherein the best set of configuration values are to optimize a predefined performance metric of the target RAN.

7. The system of claim 1, wherein the optimization rApp utilizes black-box Bayesian Optimization algorithm to optimize antenna tilt configuration values, thereby improving network coverage with controlled inter-cell interference.

8. The system of claim 1, wherein the optimization rApp utilizes Reinforcement Learning Optimization algorithm to optimize handover parameter values, thereby improving overall network retainability and reducing call drops.

9. A non-transitory machine-readable medium, comprising executable instructions that, when executed by a processing system including a processor, facilitate performance of operations, the operations comprising:
deploying one or more optimization radio access network Applications (rApps) in an open radio access network (RAN), wherein the one or more optimization rApps comprise a first rApp configured to optimize a first set of configuration value and a second rApp is configured to optimize a second set of configuration value;
deploying a digital twin engine in communication with the one or more optimization rApps, wherein the digital twin engine receives a simulating setting and network data filtered for a target radio access network (RAN) and a simulator trained to output performance projection regarding a predefined performance metric;
receiving a configuration value change from the first rApp;
generating, with the digital twin engine, the performance projection responsive to the received configuration value change and indicating a change to the predefined performance metric;
transmitting the performance projection to the first rApp for decision-making;
determining, with the first rApp, a best first set of configuration value to optimize the predefined performance metric; and
outputting the best first set of configuration value to one or more base stations in the target RAN.

10. The non-transitory machine-readable medium of claim 9, wherein the operations further comprise:
receiving, at the digital twin engine, a plurality of simulation settings prepared based on the network data relevant to the target RAN, wherein the network data comprises network configuration, user traffic demand, user spatial distribution, radio frequency propagation pattern or a combination thereof, and wherein the simulation settings reflect time and duration of interest, one or more cells of interest, one or more configuration parameters of interest, one or more Key Performance Indicators (KPI) or a combination thereof.

11. The non-transitory machine-readable medium of claim 10, wherein the generating the plurality of simulation settings further comprise generating a static configuration simulating setting, a dynamic configuration simulating setting, or a prediction based configuration simulating setting.

12. The non-transitory machine-readable medium of claim 9, wherein the operations further comprise:
receiving, at the digital twin engine, a command from the first rApp; and
in response to the command, applying, with the digital twin engine, the configuration value change to the simulation setting to generate the performance projection in form of Key Performance Indicator scores.

13. The non-transitory machine-readable medium of claim 9, wherein the operations further comprise implementing the one or more optimization rApps by using one or more optimization algorithms, wherein the first rApp utilizes Reinforcement Learning optimization algorithm for optimizing handover parameter values and the second rApp utilizes Bayesian optimization algorithm for antenna tilt configuration values and.

14. The non-transitory machine-readable medium of claim 9, wherein the operations further comprise implementing the one or more optimization rApps by using one or more optimization algorithms, wherein the first rApp utilizes combinatorial optimization-based optimization algorithm for cell transmission power values and the second rApp utilizes neural network based optimization algorithm for inactivity timer configuration values.

15. The non-transitory machine-readable medium of claim 9, wherein the operations further comprise facilitating communications between the one or more optimization rApps and the digital twin engine via a plurality of application programming interfaces (APIs), wherein the APIs includes a wrapper API interfacing with the first rApp configured to perform Reinforcement Learning based optimization.

16. A method, comprising:
executing, by a processing system including a processor, a digital twin engine to receive a simulation setting selected for a given radio access network (RAN) based on network data in open RAN, wherein the network data includes network configuration, user traffic demand, user spatial distribution, radio frequency propagation patterns or a combination thereof;
applying, by the processing system, one or more configuration value changes to the simulation setting to assess impact on predefined network performance metrics;
generating, by the processing system, performance projection scores indicating the impact on the predefined network performance metrics;
transmitting, by the processing system, the performance projection scores to an optimization RAN application (rApp) for decision-making, wherein the optimization rApp is deployed on a service management and orchestration (SMO) platform in the open RAN;
determining, by the processing system, by the optimization rApp, a best set of configuration values to optimize the predefined network performance metrics using an optimization algorithm; and
outputting, by the processing system, the best set of configuration values to one or more base stations in the given RAN via an O1 interface.

17. The method of claim 16, further comprising deploying the optimization rApp including a Reinforcement Learning model as the optimization algorithm that continuously learns from the network data to improve decision-making policies for handover parameter values.

18. The method of claim 16, further comprising deploying the optimization rApp including a Bayesian optimization model as the optimization algorithm to determine the best set of configuration values for antenna tilt configuration values.

19. The method of claim 16, wherein the performance projection includes Key Performance Indicators (KPIs) indicating average throughput, average Physical Resource Block (PRB) utilization, average Reference Signal Received Quality (RSRQ) or a combination thereof.

20. The method of claim 16, further comprising:
implementing a feedback loop where performance of the best set of configuration values output to the given RAN is monitored, whereby monitoring results are used to refine the simulation setting and the determination of the best set of configuration values.
